(19) United States
(12) Patent Application Publication
(10) Pub. No.: US 2020/0077489 A1
(43) Pub. Date: Mar. 5, 2020

(54) THREE-POSITION OPERATING MODE SWITCH

(71) Applicant: Google LLC, Mountain View, CA (US)

(72) Inventors: Michael J. Lombardi, Lake Zurich, IL (US); Mitchell Hodges, Plainfield, IL (US); Sajid Dalvi, Aurora, IL (US); Joe Allore, Mundelein, IL (US); Krzysztof Szot, Carol Stream, IL (US)

(21) Appl. No.: 16/119,188

(22) Filed: Aug. 31, 2018

(51) Int. Cl. H05B 37/02; H01H 47/00; H01H 9/02

(52) U.S. Cl. CPC H05B 37/0209; H01H 2235/01; H01H 9/02; H01H 47/00

(57) ABSTRACT

A modular electrical control system for installation in an electrical box of a premises includes a switch module configured to control power delivery to at least one external load, the switch module including a multi-position switch device that changes an operational mode of the switch module to off, toggle mode, or dimmer mode, and a removable user interface module configured to connect to the switch module, receive power from the switch module and display an interface in accordance with a setting of the multi-position switch device.

### BACKGROUND

It will be appreciated that this Background section represents the observations of the inventors, which are provided simply as a research guide to the reader. As such, nothing in this Background section is intended to represent, or to fully describe, prior art.

Lighting controls remain one of the most common devices in the world. They are in nearly every country, in most homes and rooms. In addition to widespread use, the appearance and functionality of the basic light switch remains virtually identical to what was provided in the original disclosure of the toggle light switch in 1917. However, newer functions like dimming, motion-based activation and programmed lighting schedules have been implemented in various forms. Companies have also integrated modern connectivity solutions into the standard light switch, allowing it to be controlled remotely via smartphone or other electronic device.

Some lighting systems operate in a “toggle” mode, that is having only an ON or OFF state, while others can operate in a “dimmer” mode. In dimmer mode the amount of power delivered to the light can be controlled to brighten or dim the light.

### BRIEF SUMMARY

According to an embodiment of the disclosed subject matter, a modular electrical control system for installation in an electrical box of a premises includes a switch module configured to control power delivery to at least one external load, the switch module including a multi-position switch device that changes an operational mode of the switch module to off, toggle mode, or dimmer mode, and a removable user interface module configured to connect to the switch module, receive power from the switch module and display an interface in accordance with a setting of the multi-position switch device.

According to an embodiment of the disclosed subject matter, a multi-position switch device, includes a first spring-loaded contact bar biased against a first set of contact pads, a second spring-loaded contact bar biased against a second set of contact pads, a first plunger disposed proximate to the first spring-loaded contact bar such that when the first plunger is depressed the first spring-loaded contact bar disengages from the first contact pads leaving an air gap between the first contact pads and the first contact bar, a second plunger disposed proximate to the second spring-loaded contact bar such that when the second plunger is depressed the second spring-loaded contact bar disengages from the second contact pads leaving an air gap between the second contact pads and the second spring-loaded contact bar, and a slidable switch, having a protrusion that depresses the first plunger when the switch passes into a first position, depresses the second plunger when the switch moves into a second position, and does not depress the first and second plunger when the switch moves into a third position.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows a smart electrical control system according to an embodiment of the disclosed subject matter.

FIG. 2 shows an angled view of a user interface module according to an embodiment of the disclosed subject matter.

FIG. 3 shows an exploded, angled view of a user interface module from the front according to an embodiment of the disclosed subject matter.

FIG. 4 shows an exploded view of a user interface module from the rear according to an embodiment of the disclosed subject matter.

FIG. 5 shows an exploded view of a switch module according to an embodiment of the disclosed subject matter.

FIG. 6 shows another exploded view of a switch module according to an embodiment of the disclosed subject matter.

FIG. 7 shows a side view of a multi-position switch device according to an embodiment of the disclosed subject matter.

FIG. 8 shows an exploded view of a multi-position switch device according to an embodiment of the disclosed subject matter.

FIG. 9A shows a cut-away side view of a multi-position switch device according to an embodiment of the disclosed subject matter in a default position.

FIG. 9B shows a cut-away side view of a multi-position switch device according to an embodiment of the disclosed subject matter in a depressed position.

FIG. 10 shows a close-up cut-away view of the intersection of a plunger and channel according to an embodiment of the disclosed subject matter in a default position.

FIG. 11 shows a close-up internal view of a housing according to an embodiment of the disclosed subject matter in a default position.

FIG. 12 shows various states of a slidable switch and multi-position switch device according to an embodiment of the disclosed subject matter.

FIG. 13 shows switch modules according to an embodiment of the disclosed subject matter installed in a three-way switch configuration.

FIG. 14 shows a block diagram of a switch circuit according to an embodiment of the disclosed subject matter.

FIG. 15 shows a block diagram of a switch module and UI module according to an embodiment of the disclosed subject matter.

### DETAILED DESCRIPTION

The following description is based on embodiments of the disclosed principles and should not be taken as limiting the claims with regard to alternative embodiments that are not explicitly described herein. Also, various aspects or features of this disclosure are described with reference to the drawings, wherein like reference numerals are used to refer to like elements throughout.

In this specification, numerous details are set forth in order to provide a thorough understanding of this disclosure. It should be understood, however, that certain aspects of disclosure may be practiced without these specific details, or with other methods, components, materials, etc. In other instances, well-known structures and devices are depicted in block diagram form to facilitate describing the subject disclosure.

Lighting controls are frequently found at the entry points of rooms within residential, commercial and industrial buildings. They are installed within switch boxes which are typically attached to the underlying structure of the building. Lighting controls have a standardized attachment scheme such that they can be installed, replaced and/or upgraded over time without modification to the switch box. Multiple lighting controls can control a single load, resulting in three-way or multi-way switch configurations.

A traditional simple light switch is essentially a mechanical switch device that does not require a power source to operate and operates solely in a toggle mode. Likewise, a traditional dimmer switch is normally implemented as a mechanical knob or sliding lever that can be used to adjust a variable resistor that controls a triode for alternating current (TRIAC).

Dimmer products must include a user-accessible air gap disconnect mechanism to comply with regulatory requirements (such as UL 1472). Dimmer products are typically rated for lower power (400 W, 600 W, 1000 W) than toggle products (1500 W, 1800 W). For a switch to be wired to a U.S. residential outlet, it must be a toggle switch rated to 1800 W (15 A) since the outlet is rated to 15 A. Thus, a conventional smart dimmer switch would not be compatible with an outlet. On the other hand, a toggle-only smart switch could never dim lights. The disclosed embodiments provide both modes of operation in a single switch, thereby reducing the number of products that need to be manufactured and increasing consumer flexibility to install switches anywhere in a home.

The disclosed embodiment of a smart electrical control system includes a three-position operating switch that complies with regulatory requirements and allows switching between dimmer and toggle modes. The disclosed smart electrical control system includes an in-wall light switch module and a user interface module that attaches and electrically connects to the switch module. The switch module can function in a dimmer mode or toggle mode. Various features described with respect to the embodiments of the disclosed smart electrical control system may be omitted or included in different combinations than depicted/described in the examples discussed below.

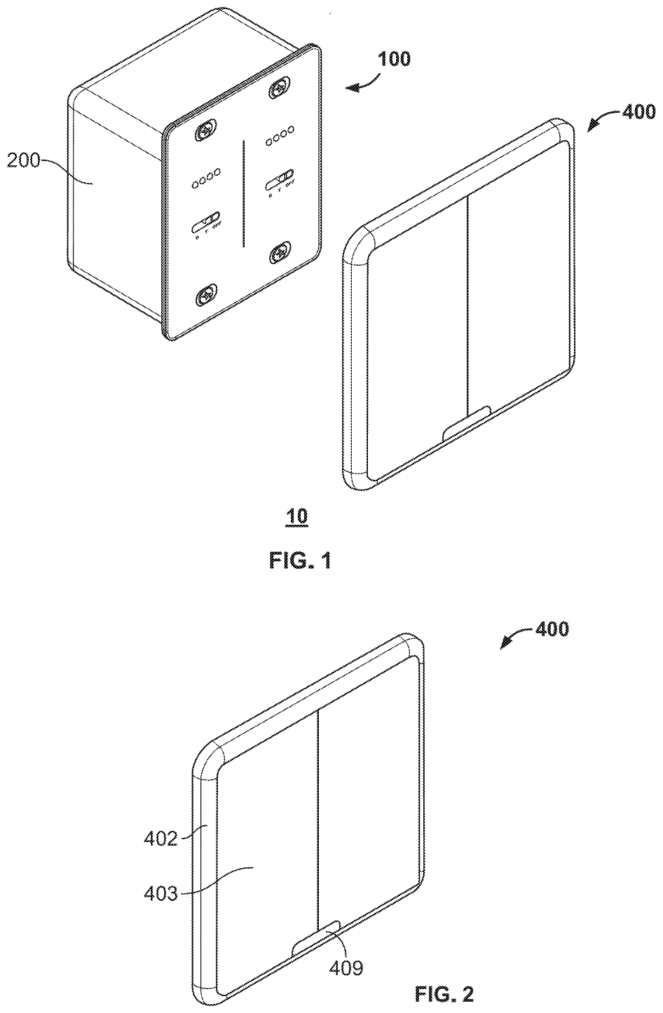

FIG. 1 depicts an embodiment of a smart electrical control system 10 according to the disclosed subject matter, including a switch box 200 housing a switch module 100 that draws power for the system 10 and implements switch functionality, and a user interface (UI) module 400 to provide a user with an interface to control the system 10. The configuration depicted is a dual-gang (two circuit) configuration, however, the switch module 100 and UI module 400 can be made in various configurations to accommodate different size and feature requirements.

FIG. 2 is an angled view of a UI module 400 according to the disclosed subject matter. The UI module includes a lens 403 and front housing 402. A sensor lens 409 is included in this embodiment. As will be described below, the UI module 400 provides controls for smart switch functionality based on a mode (e.g., toggle/dimmer) that the smart electrical control system 10 is set in.

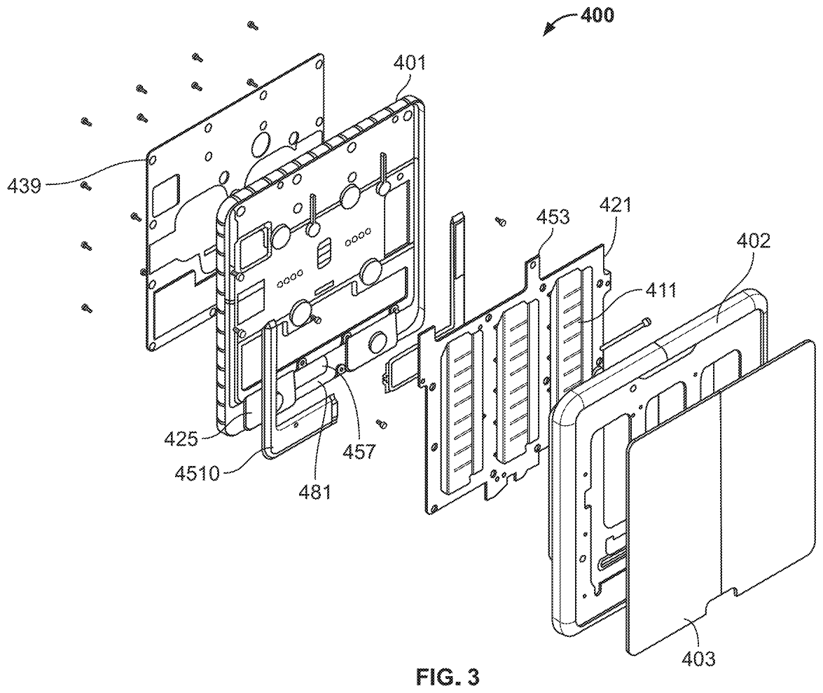

FIG. 3 is an exploded, angled view of an embodiment of the UI module 400 from the front and illustrates an example layout of some of its powered internal components. In this layout an infrared (IR) motion sensor 457 is oriented towards a mirror 481 to direct the light from the sensor lens 409 (FIG. 2) towards the IR motion sensor 457. One or more speakers 425 may be located within an acoustic housing 4510 and connected to a printed circuit board (PCB) assembly 421, which includes a processor and various controllers. The PCB assembly 421 can include a microphone 453. The PCB assembly 421 also may include, beneath a light guide assembly 411, a plurality of LEDs (not depicted) to provide output and a plurality of touch sensors (not depicted) to receive input. To diffuse the light emitted by the LEDs, the light guide assembly 411 can be implemented as molded plastic, film sheets, or the like. A rear cover 439 attaches to the rear housing 401.

The UI module 400 can display an interface for smart switch functionality in various modes, such as toggle mode or dimmer mode. For example, the PCB assembly 421 can control the LED's to display lighting through the light guide assembly 411 according to a current mode setting and thereby indicate a state of the load (e.g. a current light setting, fan setting, etc), or provide other audio/visual information to a user. The lens 403 can include a printed layer such as an additional masked pattern that allows light to be emitted only in certain areas, for example to aid in creating a display suitable for a given mode.

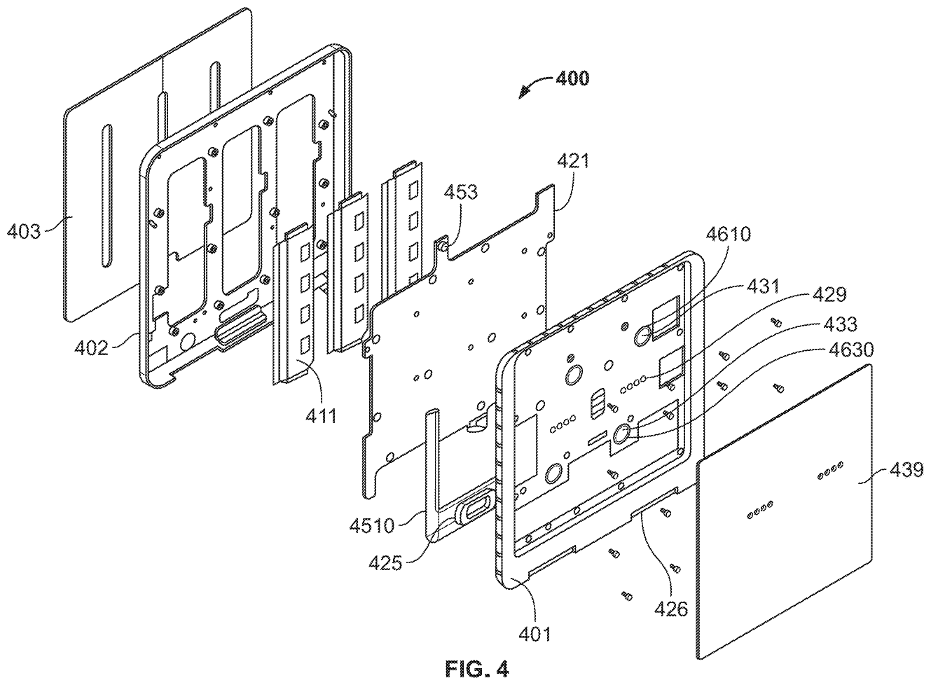

FIG. 4 is an exploded, angled view of an embodiment of the UI module 400 from the rear, depicting an example layout of various components that interact with the switch module 100 (FIG. 1). The UI module 400 includes a mechanism for attaching or fastening to an underlying switch module 100. The mechanism can be implemented, for example, via magnets, hooks, slots, clips or other types of fasteners. As will be described below, the UI module can also include a data transmission system to communicate with the switch module, for example, pins or a transceiver, an IR light emitter and IR light detector or the like, and a power transmission system to supply power to or receive power from a switch module.

The embodiment depicted in FIG. 4 includes contact pins 429 to receive/transmit power and transmit/receive data, and retention magnets 431, 433 surrounded by ferrous steel shrouds 4610, 4630 to attach to the switch module 100. One or more audio ports 426 can be formed in the rear housing 401.

The UI module 400 is not limited to the embodiments or component layouts depicted in FIGS. 3-4, but can also be constructed with different layouts and include other sensors, for example, to detect temperature, humidity, ambient light, motion, and so on. In one embodiment, a UI module 400 can include one or more of a video camera, LCD display, ambient light sensor, and IR motion sensor.

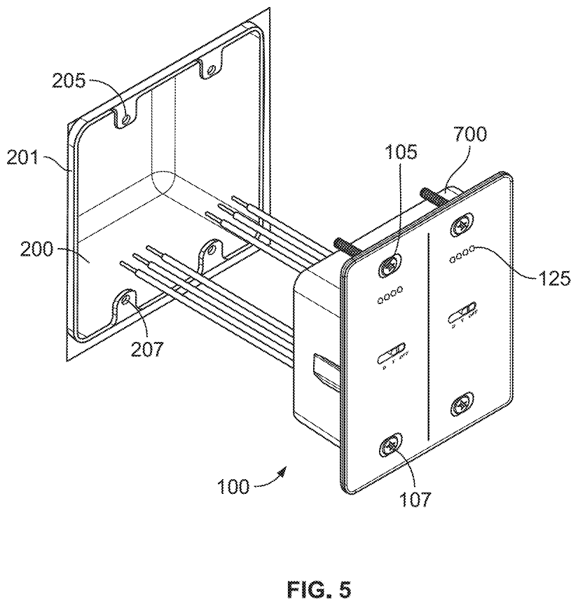

Turning now to details of the disclosed switch module 100, FIG. 5 depicts an angled, exploded view of a switch module 100 assembly in switch box 200. The switch box 200 has threaded holes, e.g., 205, 207 to retain the switch module 100 using screws, e.g., 105, 107. In typical applications the switch box 200 is surrounded by building material 201 such as drywall. In the embodiment depicted, the switch module 100 is installed into a dual gang switch box 200. The switch module 100 includes contact pins 125 which may transmit power to the UI module 400 and receive data signals from the UI module 400.

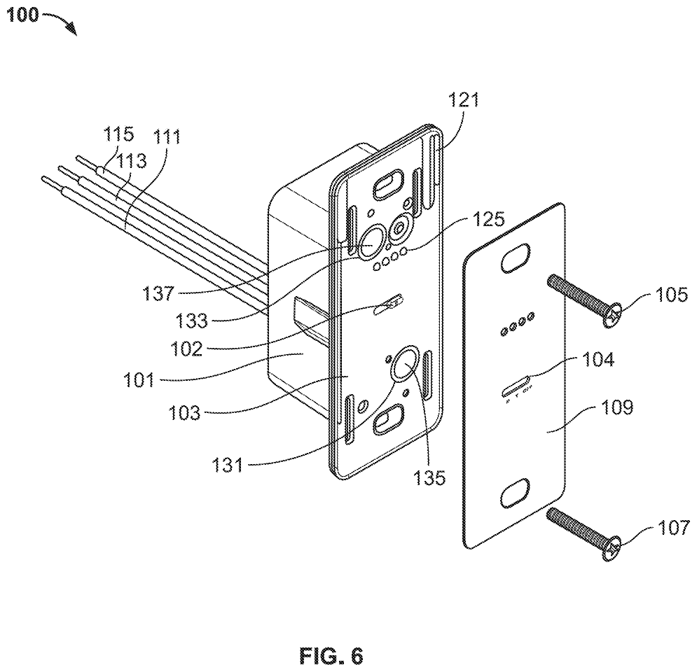

FIG. 6 is an angled, exploded view of a switch module 100 in a single-gang configuration. A first screw 105 and second screw 107 are used to retain the switch module 100 to a switch box. The switch module 100 includes front cover 109, front housing 103, and a main housing 101 that holds most of the internal components of the switch module 100, including a printed circuit board PCB assembly (not shown). The layout and configuration of the PCB and internal components can change based on the implementation of different features.

The switch module 100 incudes a plurality of connectors 111, 113, 115 for connecting the switch module 100 to a building's existing electrical wiring, e.g., through a gang box. The connectors 111, 113, 115 allow the switch module 100 to draw electrical power from the building and to execute switching functionality for the load (e.g., light, fan, etc.) that the switch module 100 is installed to control.

In the main housing 101, the switch module 100 can include a power transmission system to transmit power to the UI 400, for example, using contacts or a wireless power transmission coil. The embodiment depicted in FIG. 6 includes contact pins 125 configured to transmit power to a UI module (not shown) when attached the UI module.

The switch module 100 includes an antenna 121 disposed behind the front cover 109 to allow wireless communication with external electronic devices, e.g., smart phones, tablets, laptops, smart watches, etc. The antenna also can be used by one switch module to communicate with another switch module, for example, using wireless networking standards such as IEEE 802.15.4, which higher level protocols such as ZigBee and Thread are based on. Thus, multiple switch modules throughout a home can communicate with each other. In other embodiments, the switch module may offer no wireless connectivity and such connectivity may be included in the UI module.

Instead of peer-to-peer or one-to-many network topologies, a plurality of switch modules installed in a home may form a mesh network such that a single point of failure does not impact connectivity for other devices in the home. When a UI module 400 physically docks over a switch module 100 that is connected to the wireless mesh, the UI module 400 can use the contact pins 125 to communicate with the underlying switch module 100 and send commands and/or data through the mesh network instead of directly joining the wireless mesh. Using this configuration a UI module 400 can control any switch module on the mesh network and is not limited to controlling a switch module physically connected to the UI module.

Referring back to FIG. 6, the switch module 100 can also include a mechanism for attaching or fastening to the UI module, for example, magnets, hooks, slots, clips or other types of fasteners. In the embodiment depicted, two magnets 135, 137 are disposed behind the front cover 109, surrounded by two ferrous steel shrouds 131, 133 on all sides other than the side facing the front cover 109. The magnets 135, 137 can passively maintain a force that can be used to hold a UI module against the switch module 100, providing an additional advantage of reducing the number of parts that require interlocking or clicking that are susceptible to wear and tear.

The switch module 100 can also include a data transmission system, for example, contact pins, a transceiver, an infrared (IR) light emitter and IR light detector or the like. In one embodiment, the IR light emitter and IR light detector on the switch module 100 may be part of the same physical component. In the embodiment depicted in FIG. 6 contact pins 125 protrude through the front cover 103 and function as a data transmission system.

The switch module 100 itself can also implement a tactile switch (not shown) such that if a user presses on a front face of the switch module 100 the tactile switch will actuate and trigger an input to control a load, such as a light or fan, or trigger execution of an operation on a different device, such as turn on/off a radio. An indicator can be included on the front cover 109 to show a region for the user to press to actuate the switch module.

The switch module 100 also includes a slidable switch 102 disposed behind the front cover 109. The slidable switch 102 is accessible through opening 104 in the front cover 109.

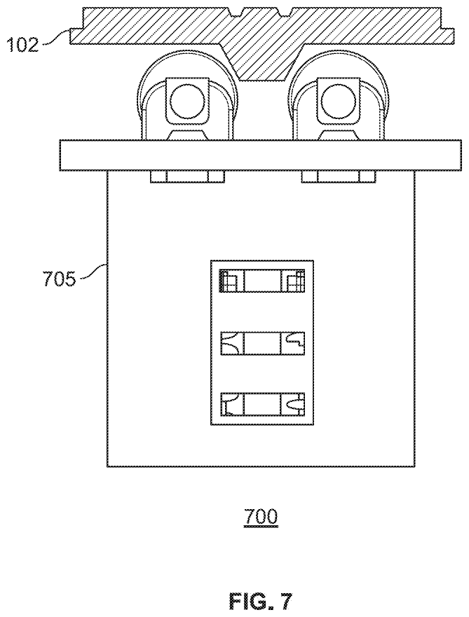

The slidable switch 102 enables a user to control the switch module 100 to implement various operating modes, such as dimmer (TRIAC-based) or toggle (relay-based) operation modes. FIG. 7 shows a side view of switch assembly 700 removed from the switch module 100. The switch assembly 700 includes a contact assembly 705 and the slidable switch 102.

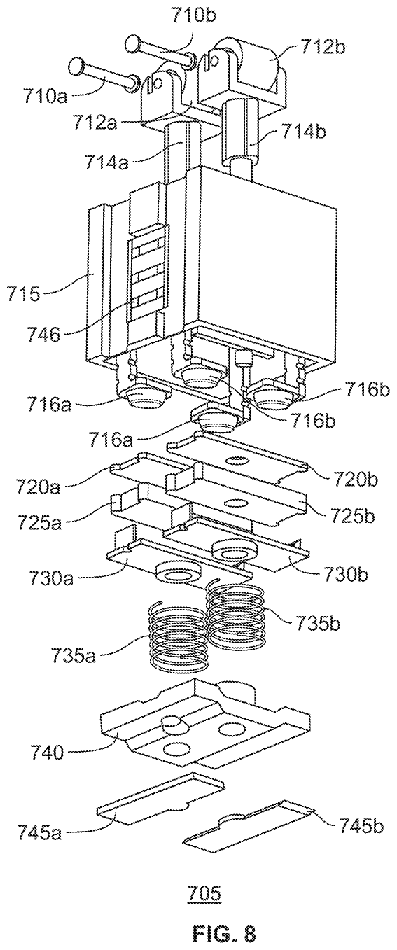

FIG. 8 shows an exploded view of the contact assembly 705, including: pins 710a and 710b, wheels 712a and 712b, plungers 714a and 714b, housing 715, contact pads 716a and 716b, contact bars 725a and 725b, insulators 730a and 730b, springs 735a and 735b, cover 740, and glue layers 745a and 745b. The contact assembly 705 can also include conductor layers 720a and 720b to lower contact resistance for the electrical path, thereby lowering heat produced by electrical current. The conductor layers 720a and 720b can be formed, for example, from AgSnO2.

The contact pads 716a, 716b, and the plungers 714a, 714b are disposed within housing 715 while the wheels 712a, 712b protrude out of a first side of the housing 715. The housing 715 can include a plurality of holes 746 that release heat which may accumulate in the housing 715. As will be described below, contact bars 725a, 725b and contact pads 716a, 716b form two independent switches that are opened or closed based on a position of the slidable switch 102 (FIG. 7).

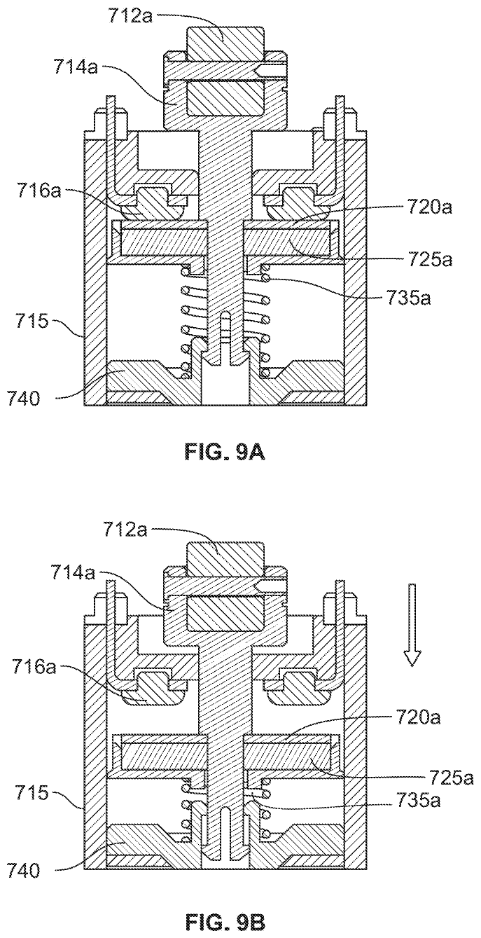

FIG. 9A shows a cut-away side view of the contact assembly in a default (closed switch) position. The spring 735a biases the contact bar 725a/conductor layer 720a against the contact pads 716a while in the default position. The depicted side view shows only half of the contact assembly. It should be understood that the full contact assembly includes a first pair of contact pads 716a which are shown biased against a first contact bar 725a in FIG. 9A, and a second pair of contact pads 716b (not shown) that may be biased against a second contact bar 725b (not shown) or separated from the second contact bar 725b (not shown) depending on the position of the plunger 714b (not shown). The position of plunger 714b (not shown) is independent of the position of plunger 714a.

FIG. 9B shows a cut-away side view of the contact assembly in the depressed (open switch) position. A force at least partially in the direction of the arrow has been applied to wheel 712a, which presses the plunger 714a to separate the contact bar 725a/conductor layer 720a from the contact pads 716a, compress the spring 735a, and thereby place the contact assembly 705 in the depressed position. As can be seen in the figure, an air-gap now exists between the contact bar 725a/conductor layer 720a and the contact pads 716a.

FIG. 9B depicts only half of the contact assembly 705. It should be understood that the contact assembly 705 includes: 1) a first plunger 714a proximate to a first contact bar 725a/conductor layer 720a and having notches that contact the first contact bar 725a/conductor layer 720a such that when the first plunger 714a is depressed it forces the first contact bar 725a/conductor layer 720a to disengage from the first pair of contact pads 716a, leaving an air gap between the first contact pads 716a and the first contact bar 725a/conductor layer 720a; and 2) a second plunger 714b proximate to a second contact bar 725b/conductor layer 720b and having notches that contact the second contact bar 725b/conductor layer 720b such that when the second plunger 714b is depressed it forces the second contact bar 725b/conductor layer 720b to disengage from the second pair of contact pads 716b, leaving an air gap between the second contact pads 716b and the second contact bar 725b/conductor layer 720b.

As shown in FIG. 8, the contact assembly 705 includes wheels 712a, 712b that can each be individually depressed to open a respective switch. The wheels 712a, 712b are each attached on a distal end portion of the first and second plungers 714a, 714b opposite the contact pads 716a, 716b such that a protrusion on the slidable switch 102 can engage each wheel 712a, 712b and causes the wheel to turn as the switch moves into or out of the first or second position.

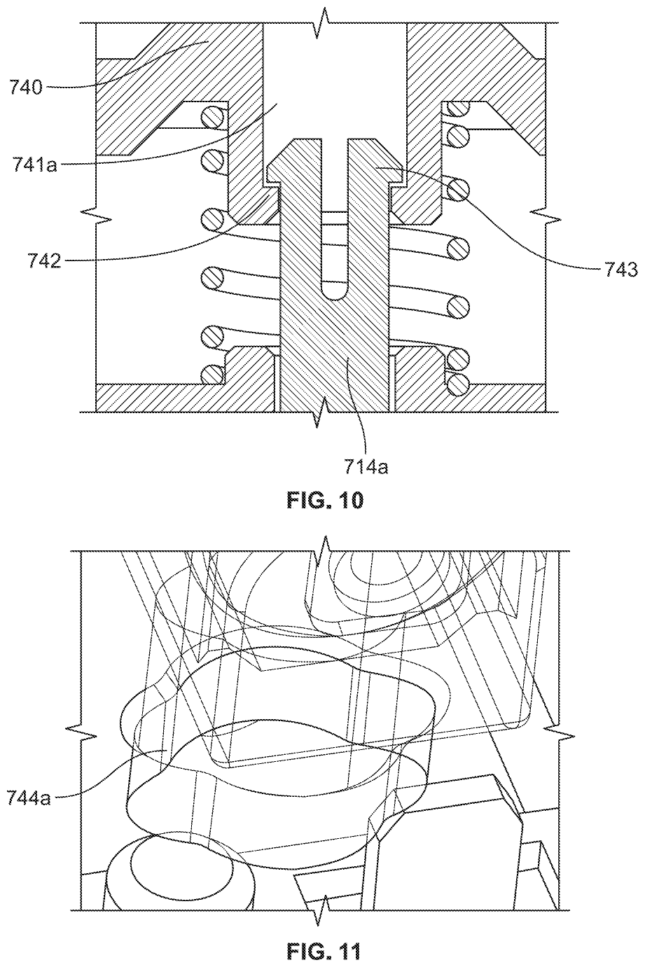

The cover 740 includes a first channel and a second channel that receives the first and second plungers 714a, 714b. FIG. 10 shows a close-up cut-away view of the intersection of the plunger 714a, the cover 740 and the channel 741a. The channel 741a includes an edge portion 742 that extends inward and engages extension portions 743 on the plunger 714a to prevent the plunger 714a from exiting the channel in a first direction. It should be understood that the cover 740 includes a second channel 741b that is similarly constructed to engage with plunger 714b.

FIG. 11 shows a close-up internal view an embodiment of the side of the housing 715 (FIG. 8) that is opposite cover 740 (FIG. 8). The side of the housing depicted in FIG. 11 includes a first opening 744a through which the first plunger 714a passes, and a second similar opening (not depicted) through which the second plunger 714b passes. The opening 744a is formed in a shape that conforms with a shape of a portion of the plunger 714a. In one embodiment, the shape has a design that prevents the plunger 714a from rotating as it passes through the opening 744a.

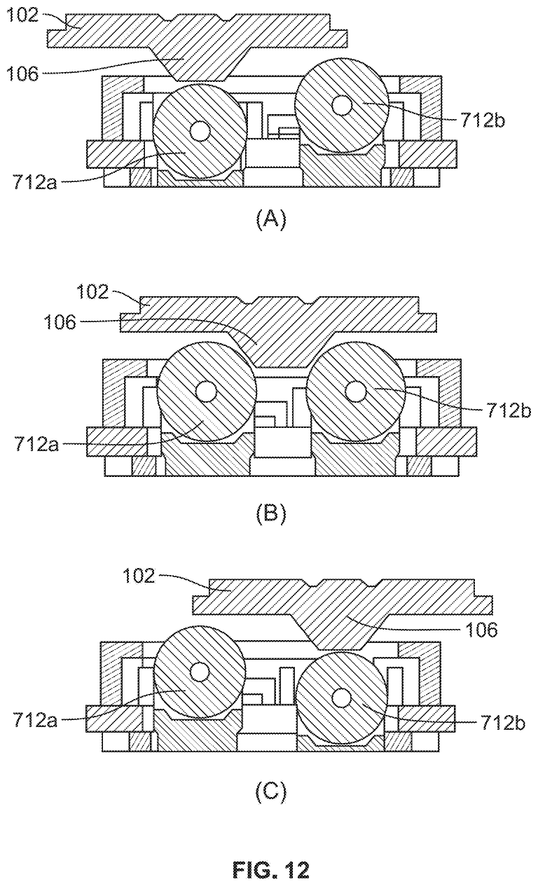

FIG. 12 depicts three possible states that the contact assembly 705 can be set in based on the position of the slidable switch 102. In each position the protrusion 106 from the slidable switch 102 sets that state of the switch assembly 100 by depressing one of or neither of the wheels 712a, 712b. That is, the protrusion 106 depresses the first plunger 714a when the slidable switch 102 passes into a first position, depresses the second plunger 714b when the slidable switch 102 moves into a second position, and disengages from the first and second plungers 714a, 714b when the slidable switch 102 moves into a third position.

More specifically, in position (A) the slidable switch 102 is placed in a position in which the protrusion 106 depresses wheel 712a, which in turn opens the contacts of the corresponding switch (i.e., as shown in FIG. 9B). In position (A) the slidable switch 102 does not depress wheel 712b, which therefore remains in a default position with its corresponding switch contacts closed (i.e., as shown in FIG. 9A).

In position (B) the slidable switch 102 is placed in a position in which the protrusion 106 does not depress either of wheels 712a or 712b. Both corresponding switch contacts therefore remain closed by default.

In position (C) the slidable switch 102 is placed in a position in which the protrusion 106 depresses wheel 712b, which in turn opens the contacts of the corresponding switch. In position (C) the slidable switch 102 does not depress wheel 712a, which remains in a default position with its corresponding switch contacts closed.

As shown in FIG. 6, the disclosed switch assembly can be installed as part of a switch module 100 that can operate in either a toggle mode or a dimmer mode. Depending on the installation setup, the terminals to connectors 111, 113, and 115 can facilitate different types of controls. In one embodiment the connectors 111, 113, and 115 are connected to a common terminal and two traveler terminals, allowing execution of multiple switch functions as will be described below.

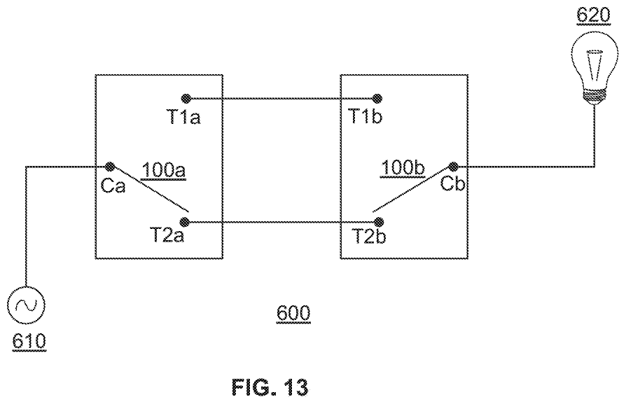

FIG. 13 depicts a pair of disclosed switch modules 100a, 100b installed in a three-way switch configuration 600 in a premises. Switch module 100a includes a common terminal Ca and a pair of traveler terminals T1a, T2a. Similarly, module 100b includes a common terminal Cb and a pair of traveler terminals T1b, T2b. The switch module 100a includes a relay circuit that controls a switchable connection between Ca and either of T1a or T2a. The configuration 600 permits either of switch module 100a or 100b to control delivery of power from a main source 610 to a load 620 by switching a connection between the common and traveler terminals. Switch modules 100a, 100b can therefore be installed in separate locations within a premises and both control the load. It should be noted, however, that in configuration 600 only switch module 100b (i.e., the switch module with a common terminal connected to the load 620) can optionally operate in either a dimmer mode or a toggle mode.

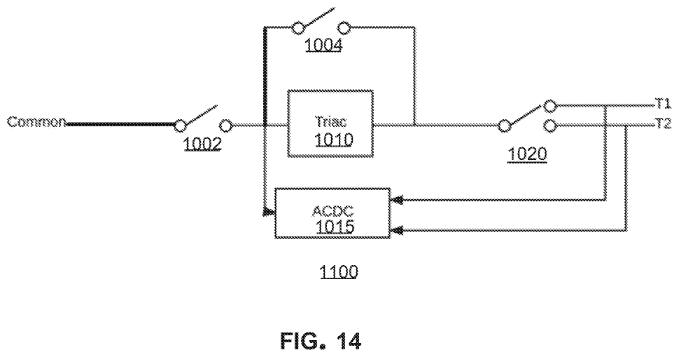

FIG. 14 depicts a block diagram of a switch circuit 1100 which can be included in an embodiment of the disclosed switch module 100. The switch circuit 1100 includes a first relay 1002, a second relay 1004, a TRIAC 1010, an AC-to-DC converter circuit 1015, and a third relay 1020. It should be understood that additional components can be included in the switch circuit 1100. The setting of the first relay 1002 and second relay 1004 are controlled by the slidable switch 102 and contact assembly 705, as described above. That is, referring to FIGS. 12 and 14, in one configuration first relay 1002, for example, can be opened/closed by slidable switch 102 depressing or releasing wheel 712a while second relay 1004 is opened/closed by slidable switch 102 depressing or releasing wheel 712b.

Referring to FIGS. 12 and 14, in the position depicted in FIG. 12 (A) wheel 712a is depressed, opening first relay 1002 while leaving second relay 1004 closed. In this setting the switch module operates in an ‘off’ mode. That is, the common terminal is electrically disconnected from TRIAC 1010, ACDC 1015, and relay 1020 by a safety air-gap due to the open relay 1002.

In position (B) neither of wheel 712a nor 712b are depressed, leaving both the first relay 1002 and the second relay 1004 in a closed state by default. In this setting the switch module operates in a ‘toggle’ mode. Power received at the common terminal bypasses the TRIAC 1010, which is electrically disabled in this mode. The flow of power passes through and is controlled by third relay 1020.

In position (C) wheel 712b is depressed, thereby opening second relay 1004 and leaving first relay 1002 closed. In this setting the switch module operates in a ‘dimmer’ mode. The common terminal is electrically connected to TRIAC 1010, thereby allow the flow of received power to pass through and be controlled by TRIAC 1010, which functions as a dimming controller of load 620.

The two relays 1002, 1004 and TRIAC 1010 therefore enable either of a toggle or dimmer mode of operation. That is, if the user wishes to control a load using on/off toggle commands without dimming, the user can move the slidable switch to a position to set first relay 1002 and second relay 1004 both closed. If the user wishes to control a load using dimming functionality, the user can move the slidable switch into a position to set first relay 1002 closed and second relay 1004 open. Whenever the user wishes to cease providing power to the load the user can move the slidable switch to a position to set the first relay 1002 open, thereby creating an air gap in the switch circuit 1100 between the common terminal and the load.

Turning now to cooperation between the UI module 400 and the switch module 100, FIGS. 4 and 6 show retention magnets 431, 433 positioned to draw the UI module 400 into alignment with the magnets 135, 137 of the switch module 100. In this manner, the UI module 400 is automatically retained in proper alignment and position with the switch module 100 by the retention force of the magnets.

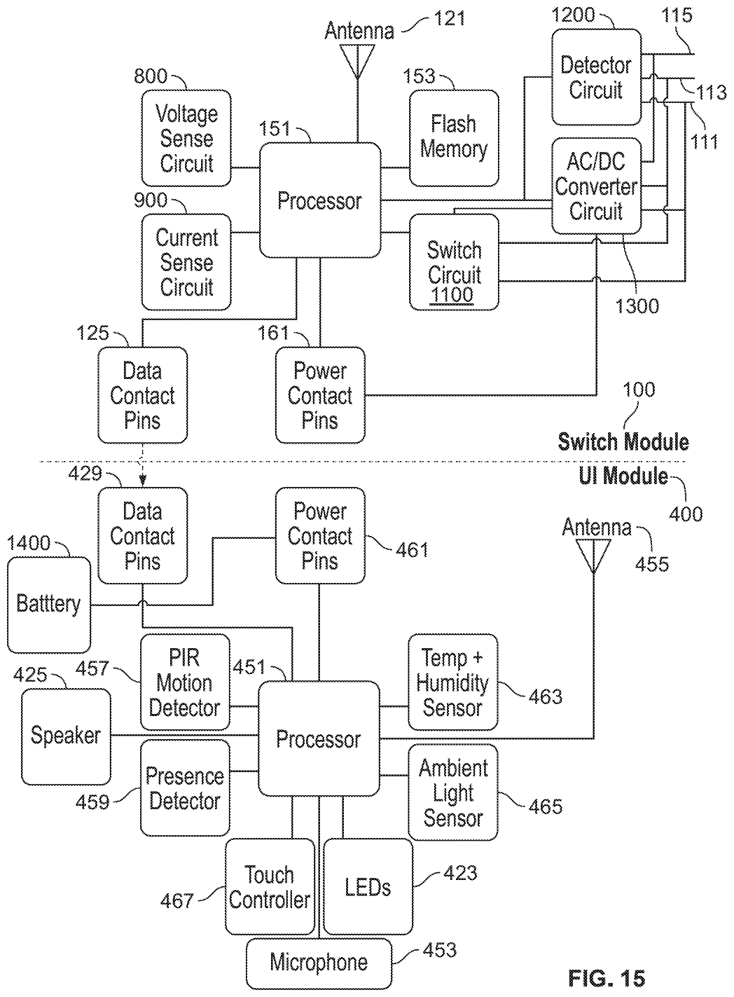

FIG. 15 is a block diagram of the switch module 100 and the UI module 400. The switch module 100 includes a processor 151 which controls functions executed by the switch module 100. The processor 151 may also comprise its own memory, modem and/or other functions to comprise a “system on a chip” (SoC). The switch module 100 can include a Hall Effect sensor (not depicted) connected to the processor 151 and can include one or more secondary processors (not depicted) to handle certain designated functions or to otherwise aid the processor 151. The switch module 100 also powers contact pins 161 that are capable of transmitting power to the UI module 400.

Processor 151 can transmit data and commands to the UI module 400 via data contact pins 125. Data contact pins 125 can be separate from power contact pins 161 or can be one and the same. The switch module 100 can include flash memory 153 external to the processor 151. The switch module 100 also includes an antenna 121 connected to the processor 151. The switch module 100 further includes a switch circuit 1100, detector circuit 1200, and AC-DC converter circuit 1300 connected to and controlled by the processor 151.

The switch circuit 1100 can include, as described above (FIG. 14) relay circuits, a triode for alternating current (TRIAC) circuit, and a multi-position switch that allows a user to choose between use of a relay (toggle mode) and TRIAC (dimmer mode) for controlling the power delivered to a load. The switch module 100 can also include a voltage sense circuit 800 and a current sense circuit 900 to allow the switch module 100 to monitor the power used by the load attached to it.

The UI module 400 has a processor 451 that can be similar to that of the switch module 100. The processor 451 may have additional components and functionality embedded to comprise a SoC. The UI module 400 can include an antenna 455 which allows two way data communication using protocols such as WiFi. Additional antennas and wireless protocols may be implemented as well but are omitted from the illustration for simplification.

The UI module 400 can include data contact pins 429 and power contact pins 461 to receive/transmit data from the processor 451 and to receive power from the switch module 100 to power the UI module 400 components and charge battery 1400. Data contact pins 429 can be separate from power contact pins 461 or can be one and the same. In one implementation the processor 451 can transmit a status request to the switch module 100 to check, for example, which mode the switch module 100 is set in or a state of the load controlled by the switch module 100. Based on the received response, the processor 451 can control the UI module 400 to display an appropriate interface. In this way the UI module 400 can display an interface in accordance with setting of the slidable switch that sets the switch module 100 operational mode.

The UI module 400 also includes a speaker 425 and microphone 453 connected to the processor 451. As previously mentioned, LEDs 423 are included in the UI module 400 and are connected to and controlled by the processor 451 to, for example, display a load status or function as part of an interface. A variety of sensors can be connected to the processor 451, including: temperature and humidity 463, ambient light 465, touch 467, presence 459 and motion 457.

The disclosed smart electrical control system can be a part of a smart-home environment which can include a structure, such as, for example, an apartment, office building, garage, factory, mobile home, or the like. The smart electrical control system can control and/or be connected to devices and systems inside or outside of the structure.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A modular electrical control system for installation in an electrical box of a premises, comprising:
a switch module configured to control power delivery to at least one external load, the switch module including a multi-position switch device that changes an operational mode of the switch module to off, toggle mode or dimmer mode; and
a removable user interface module configured to connect to the switch module, receive power from the switch module, and display an interface in accordance with a setting of the multi-position switch device.

2. The modular electrical control system of claim 1, wherein the multi-position switch device comprises:
a first contact bar biased against a first set of contact pads;
a second contact bar biased against a second set of contact pads;
a first plunger disposed proximate to the first contact bar such that when the first plunger is depressed the first contact bar is disengaged from the first contact pads, leaving an air gap between the first contact pads and the first contact bar;
a second plunger disposed proximate to the second contact bar such that when the second plunger is depressed the second contact bar is disengaged from the second contact pads, leaving an air gap between the second contact pads and the second contact bar; and
a slidable switch, having a protrusion that depresses the first plunger when the switch moves into a first position, depresses the second plunger when the switch moves into a second position, and does not depress the first or second plunger when the switch moves into a third position

3. The modular electrical control system of claim 2, wherein:
the switch module includes:
a common terminal electrically connected to a power source, and
a TRIAC that controls an amount of power delivered to the external load; and
the first contact bar connects the common terminal to the TRIAC when the first contact bar contacts the first contact pads.

4. The modular electrical control system of claim 3, wherein:
the switch module further includes a relay circuit that controls a flow of power to the external load; and
the second contact bar connects the common terminal to the relay circuit when the second contact bar contacts the second contact pads and the first contact bar contacts the first contact pads.

5. The modular electrical control system of claim 2, wherein the first and second plungers each have a wheel attached on a distal end portion opposite the corresponding contact pads such that the switch protrusion engages each wheel and causes the wheel to turn as the switch moves into or out of the first or second position.

6. The modular electrical control system of claim 5, wherein the first and second contact pads and the first and second plungers are disposed within a housing such that the wheels protrude out of a first side of the housing.

7. The modular electrical control system of claim 6, wherein:
the housing includes an assembly cover attached to a second side of the housing opposite the first side, the assembly cover having a first channel and a second channel that receives the first and second plungers;
the bias of the first and second contact pads against the first and second contact bars is maintained by force applied to the first and second contact bars by first and second coil springs; and
the first and second channels each have edge portions that extend inward and engage extension portions of the plungers to prevent the force exerted by the coil springs from causing the plungers to exit the channel in a first direction.

8. The modular electrical control system of claim 6, wherein the housing includes a first and second opening on the first side through which the first and second plungers pass through, the first and second openings being formed in a shape that conforms with a shape of a portion of the first and second plungers, the shape having a design that prevents the first and second plungers from rotating as they pass through the first and second openings.

9. The modular electrical control system of claim 6, wherein the housing includes a plurality of holes that release heat accumulated in the housing.

10. The modular electrical control system of claim 6, wherein the housing includes an insulator layer disposed between the assembly cover and each of the contact bars.

11. A multi-position switch device, comprising:
a first spring-loaded contact bar biased against a first set of contact pads;
a second spring-loaded contact bar biased against a second set of contact pads;
a first plunger disposed proximate to the first spring-loaded contact bar such that when the first plunger is depressed the first spring-loaded contact bar disengages from the first contact pads leaving an air gap between the first contact pads and the first contact bar;
a second plunger disposed proximate to the second spring-loaded contact bar such that when the second plunger is depressed the second spring-loaded contact bar disengages from the second contact pads leaving an air gap between the second contact pads and the second spring-loaded contact bar; and
a slidable switch, having a protrusion that depresses the first plunger when the switch passes into a first position, depresses the second plunger when the switch moves into a second position, and does not depress the first and second plunger when the switch moves into a third position.

12. The multi-position switch device of claim 11, wherein the first and second plungers each have a wheel attached on a distal end portion opposite the corresponding contact pads such that the switch protrusion engages each wheel and causes the wheel to turn as the switch moves into or out of the first or second position.

13. The multi-position switch device of claim 12, wherein the first and second contact pads and the first and second plunger are disposed within a housing such that the wheels protrude out of a first side of the housing.

14. The multi-position switch device of claim 13, wherein the housing includes an assembly cover attached to a second side of the housing opposite the first side, the assembly cover having a first channel and a second channel that receives the first and second plungers, and the first and second channels each have having edge portions that extend inward and engage extension portions of the plungers to prevent the force exerted by the coil springs from causing the plungers to exit the channel in a first direction.

15. The multi-position switch device of claim 13, wherein the housing includes a first and second opening on the first side through which the first and second plungers pass through, the first and second openings being formed in a shape that conforms with a shape of a portion of the first and second plungers, the shape having a design that prevents the first and second plungers from rotating as they pass through the first and second openings.

16. The multi-position switch device of claim 13, wherein the housing includes a plurality of holes that release heat accumulated in the housing.

17. The multi-position switch device of claim 13, wherein the housing includes an insulator layer disposed between the assembly cover and each of the contact bars.
